(19) United States
(12) Patent Application Publication
(10) Pub. No.: US 2008/0218472 A1
(43) Pub. Date: Sep. 11, 2008

(54) INTERFACE TO CONVERT MENTAL STATES AND FACIAL EXPRESSIONS TO APPLICATION INPUT

(75) Inventors: Randy Breen, Mill Valley, CA (US); Tan Thi Thai Le, Pyrmont (AU)

Correspondence Address: FISH & RICHARDSON P.C., PO BOX 1022, MINNEAPOLIS, MN, 55440-1022, US

(73) Assignee: EMOTIV SYSTEMS PTY., LTD., Pyrmont (AU)

(21) Appl. No.: 11/682,300

(22) Filed: Mar. 5, 2007

(51) Int. Cl. G09G 5/00

(52) U.S. Cl. 345/156

(57) ABSTRACT

A method of interacting with an application includes receiving, in a processor, data generated based on signals from one or more bio-signal detectors on a user, the data representing a mental state or facial expression of the user, generating an input event based on the data representing the mental state or facial expression of the user of the user, and passing the input event to an application.

### BACKGROUND

The present invention relates generally to interaction with machines using mental states and facial expressions.

Interactions between humans and machines are usually restricted to the use of input devices such as keyboards, joy sticks, mice, trackballs and the like. Such input devices are cumbersome because they must be manually operated, and in particular operated by hand. In addition, such interfaces limit a user to providing only premeditated and conscious commands.

A number of input devices have been developed to assist disabled persons in providing premeditated and conscious commands. Some of these input devices detect eyeball movement or are voice activated to minimize the physical movement required by a user in order to operate these devices. However, voice-controlled systems may not be practical for some users or in some environments, and devices which do not rely on voice often have a very limited repertoire of commands. In addition, such input devices must be consciously controlled and operated by a user.

### SUMMARY

In one aspect, the invention is directed to a method of interacting with an application. The method includes receiving, in a processor, data generated based on signals from one or more bio-signal detectors on a user, the data representing a mental state or facial expression of the user, and generating an input event based on the data representing the mental state or facial expression of the user of the user, and passing the input event to an application.

In another aspect, the invention is directed to a program product, tangibly stored on machine readable medium, the product comprising instructions operable to cause a processor to receive data representing a mental state or facial expression of a user, generate an input event based on the data representing the mental state or facial expression of the user, and pass the input event to an application

Implementations of these invention may include one or more of the following features. The data may represent a mental state of the user, for example, a non-deliberative mental state, e.g., an emotion. The bio-signals may comprise electroencephalograph (EEG) signals. The application may not be configured to process the data. The input event may be a keyboard event, a mouse event, or a joystick event. Generating the input event may include determining whether the data matches a trigger condition. Determining may include comparing the data to a threshold, e.g., determining whether the data has crossed the threshold. User input may be received selecting the input event or the trigger condition.

In another aspect, the invention is directed to a system that includes a processor configured to receive data representing a mental state or facial expression of a user, generate an input event based on the datum representing of a state of the user, and pass the input event to an application.

Implementations of the invention may include one or more of the following features. The system may include another processor configured to receive bio-signal data, detect the mental state or facial expression from the bio-signal data, generate data representing the a mental state or facial expression, and direct the data to the processor. The system may include a headset having electrodes to generate the bio-signal data.

Advantages of the invention may include one or more of the following. Mental states and facial expressions can be converted automatically into input events, e.g., mouse, keyboard or joystick events, for control of an application on a computer. A software engine capable of detecting and classifying mental states or facial expressions based on biosignals input can be used to control an application on a computer without modification of the application. A mapping of mental states and facial expressions to input events can be established quickly, reducing cost and ease of adaptation of such a software engine to a variety of applications.

The details of one or more embodiments of the invention are set forth in the accompanying drawings and the description below. Other features, objects, and advantages of the invention will be apparent from the description and drawings, and from the claims.

### DRAWINGS

FIG. 1 is a schematic diagram illustrating the interaction of a system for detecting and classifying states of a user and a system that uses the detected states.

FIG. 2 is a diagram of a look-up table to associate states of a user with input events.

FIG. 3 is a schematic of a graphical user interface for a user to map state detections to input events.

FIG. 4A is a schematic diagram of an apparatus for detecting and classifying mental states, such as non-deliberative mental states, such as emotions.

FIGS. 4B-4D are variants of the apparatus shown in FIG. 4A.

Like reference symbols in the various drawings indicate like elements.

### DESCRIPTION

It would be desirable to provide a manner of facilitating communication between human users and machines, such as electronic entertainment platforms or other interactive entities, in order to improve the interaction experience for a user. It would also be desirable to provide a means of interaction of users with one more interactive entities that is adaptable to suit a number of applications, without requiring the use of significant data processing resources. It would moreover be desirable to provide technology that simplifies human-machine interactions.

The present invention relates generally to communication from users to machines. In particular, a mental state or a facial expression of a subject can be detected and classified, a signal to represent this mental state or facial expression can be generated, and the signal representing the mental state or facial expression can be converted automatically into a conventional input event, e.g., a mouse, keyboard or joystick event, for control of an application on a computer. The invention is suitable for use in electronic entertainment platform or other platforms in which users interact in real time, and it will be convenient to describe the invention in relation to that exemplary but non limiting application.

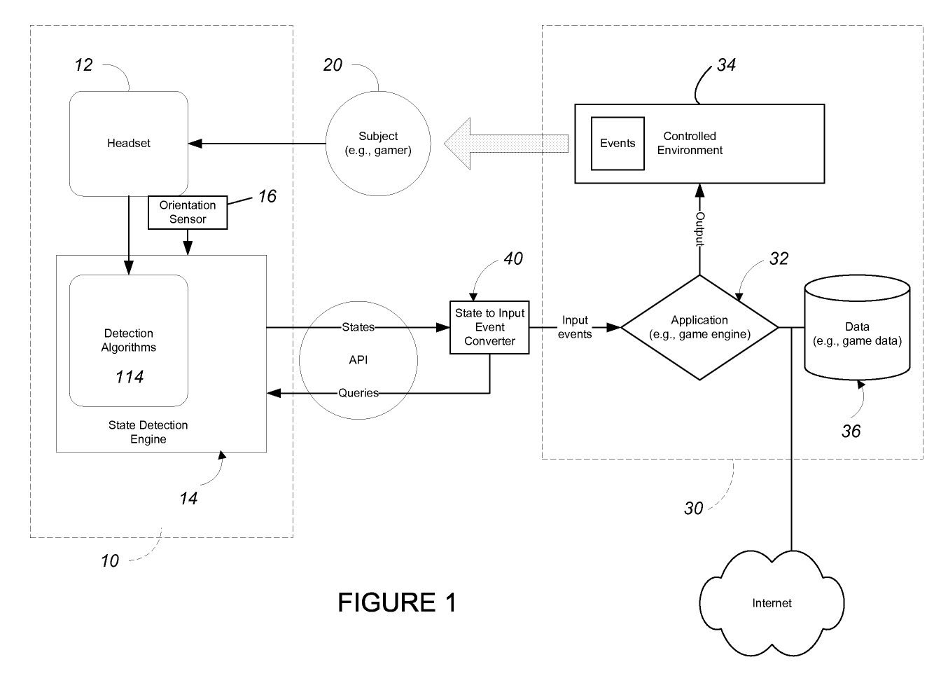

Turning now to FIG. 1, there is shown a system 10 for detecting and classifying mental states and facial expressions (collectively simply referred to as “states”) of a subject and generating signals to represent these states. In general, the system 10 can detect both non-deliberative mental states, for example emotions, e.g., excitement, happiness, fear, sadness, boredom, and other emotions, and deliberative mental states, e.g., a mental command to push, pull or manipulate an object in a real or virtual environment. Systems for detecting mental states are described in U.S. application Ser. No. 11/531,265, filed Sep. 12, 2006 and U.S. application Ser. No. 11/531,238, filed Sep. 12, 2006, both of which are incorporated by reference. Systems for detecting facial expressions are described in U.S. application Ser. No. 11/531,117, filed Sep. 12, 2006, which is incorporated by reference.

The system 10 includes two main components, a neuro-physiological signal acquisition device 12 that is worn or otherwise carried by a subject 20, and a state detection engine 14. In brief, the neuro-physiological signal acquisition device 12 detects bio-signals from the subject 20, and the state detection engine 14 implements one or more detection algorithms 114 that convert these bio-signals into signals representing the presence (and optionally intensity) of particular states in the subject. The state detection engine 14 includes at least one processor, which can be a general-purpose digital processor programmed with software instructions, or a specialized processor, e.g., an ASIC, that perform the detection algorithms 114. It should be understood that, particularly in the case of a software implementation, the mental state detection engine 14 could be a distributed system operating on multiple platforms.

In operation, the mental state detection engine can detect states practically in real time, e.g., less than a 50 millisecond latency is expected for non-deliberative mental states. This can enable detection of the state with sufficient speed for person-to-person interaction, e.g., with avatars in a virtual environment being modified based on the detected state, without frustrating delays. Detection of deliberative mental states may be slightly slower, e.g., with less than a couple hundred milliseconds, but is sufficiently fast to avoid frustration of the user in human-machine interaction.

The system 10 can also include a sensor 16 to detect the orientation of the subject's head, e.g., as described in U.S. Application Ser. No. 60/869,104, filed Dec. 7, 2006, which is incorporated by reference.

The neuro-physiological signal acquisition device 12 includes bio-signal detectors capable of detecting various bio-signals from a subject, particularly electrical signals produced by the body, such as electroencephalograph (EEG) signals, electrooculargraph (EOG) signals, electomyograph (EMG) signals, and the like. It should be noted, however, that the EEG signals measured and used by the system 10 can include signals outside the frequency range, e.g., 0.3-80 Hz, that is customarily recorded for EEG. It is generally contemplated that the system 10 is capable of detection of mental states (both deliberative and non-deliberative) using solely electrical signals, particularly EEG signals, from the subject, and without direct measurement of other physiological processes, such as heart rate, blood pressure, respiration or galvanic skin response, as would be obtained by a heart rate monitor, blood pressure monitor, and the like. In addition, the mental states that can be detected and classified are more specific than the gross correlation of brain activity of a subject, e.g., as being awake or in a type of sleep (such as REM or a stage of non-REM sleep), conventionally measured using EEG signals. For example, specific emotions, such as excitement, or specific willed tasks, such as a command to push or pull an object, can be detected.

In an exemplary embodiment, the neuro-physiological signal acquisition device includes a headset that fits on the head of the subject 20. The headset includes a series of scalp electrodes for capturing EEG signals from a subject or user. These scalp electrodes may directly contact the scalp or alternatively may be of a non-contact type that do not require direct placement on the scalp. Unlike systems that provide high-resolution 3-D brain scans, e.g., MRI or CAT scans, the headset is generally portable and non-constraining.

The electrical fluctuations detected over the scalp by the series of scalp electrodes are attributed largely to the activity of brain tissue located at or near the skull. The source is the electrical activity of the cerebral cortex, a significant portion of which lies on the outer surface of the brain below the scalp. The scalp electrodes pick up electrical signals naturally produced by the brain and make it possible to observe electrical impulses across the surface of the brain.

The state detection engine 14 is coupled by an interface, such as an application programming interface (API), to a system 30 that uses the states. The system 30 receives input signals generated based on the state of the subject, and use these signals as input events. The system 30 can control an environment 34 to which the subject or another person is exposed, based on the signals. For example, the environment could be a text chat session, and the input events can be keyboard events to generate emoticons in the chat session. As another example, the environment can be a virtual environment, e.g., a video game, and the input events can be keyboard, mouse or joystick events to control an avatar in the virtual environment. The system 30 can include a local data store 36 coupled to the engine 32, and can also be coupled to a network, e.g., the Internet. The engine 32 can include at least one processor, which can be a general-purpose digital processor programmed with software instructions, or a specialized processor, e.g., an ASIC. In addition, it should be understood that the system 30 could be a distributed system operating on multiple platforms.

Residing between the state detection engine 14 and the application engine 32 is a converter application 40 that automatically converts the signal representing state of the user from state detection engine 14 into a conventional input event, e.g., a mouse, keyboard or joystick event, that is usable by the application engine 32 for control of the application engine 32. The converter application 40 could be considered part of the API, but can be implemented as part of system 10, as part of system 30, or as an independent component. Thus, the application engine 32 need not be capable of using or accepting as an event the data output by the state detection engine 14.

In one implementation, the converter application 40 is software running on the same computer as the application engine 32, and the detection engine 14 operates on a separate dedicated processor. The converter application 40 can receive the state detection results from state detection engine 14 on a near-continuous basis. The converter application 40 and detection engine 14 can operate in a client-server relationship, with the converter application repeatedly generating requests or queries to the detection engine 14, and the detection engine 14 responding by serving the current detection results. Alternatively, the detection engine 14 can be configured to push detection results to the converter application 40. If disconnected, the converter application 40 can automatically periodically attempt to connect to the detection engine 14 to re-establish the connection.

As noted above, the converter application 40 maps detection results into conventional input events. In some implementations, the converter application 40 can generate input events continuously while a state is present. In some implementations, the converter application 40 can monitor a state for changes and generate an appropriate input result when a change is detected.

In general, converter application can use one or more of the following types of trigger conditions:

“Up”—For quantitative detections, an input event is triggered when a detection crosses from below a threshold to above the threshold. For binary detections an input event is triggered when a detection changes from absence to presence of the state.

“Down”—For quantitative detections, an input event is triggered when a detection crosses from above a threshold to below. For a given state, the threshold for “Down” may be different, e.g., lower, than the threshold for “Up”. For binary detections an input event is triggered when a detection changes from presence to absence of the state.

“Above”—For quantitative detections, an input event is triggered repeatedly while detection is above a threshold. For binary detections, an input event is triggered repeatedly while a state is present.

“Below”—For quantitative detections, an input event is triggered repeatedly while detection is below a threshold. Again, for a given state, the threshold for “below” may be different, e.g., lower, than the threshold for “above”. For binary detections, an input event is triggered repeatedly while the state is absent.

In particular, when the converter application 40 determines that a detection result has moved from absence of a state to presence of a state, the converter application 40 can generate the input event that has been associated with the state. However, for some states, when the converter application 40 determines that a detection result has moved from presence of a state to absence of a state, the converter application 40 need not generate an input event. As an example, when a user begins to smile, the detection result will change from absence of smile to presence of smile. This can trigger the converter application to generate an input event, e.g., keyboard input of a smile emoticon “:-)”. On the other hand, if the user stops smiling, the converter application 40 need not generate an input event.

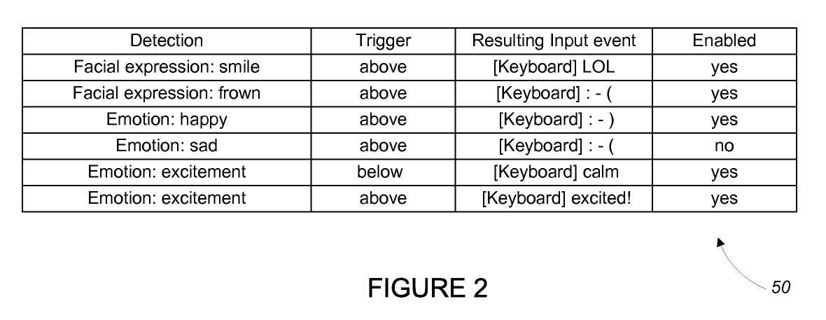

Referring to FIG. 2, the converter application 40 can include a data structure 50, such as a look-up table, that maps combinations of states and trigger types to input events. The data structure 50 can include an identification of the state, an identification of the trigger type (e.g., “up”, “down”, “above” or “below” as discussed above), and the associated input event. If a detection listed in the table undergoes the associated trigger, the converter application generates the associate input event.

It is possible for different state detections to generate the same input event. For example, if the detection algorithm 14 detects either the facial expression of a smile or the emotional state of happiness, the converter application 40 could generate a smile text emoticon “:-)”.

It is possible to have the same state detections with different triggers types, typically to generate different events. For example, the excitement detection could include both an “Above” trigger to indicate that the user is excited and a “Down” trigger to indicate that the user is calm. As noted above, the thresholds for “Up” and “Down” may be different. For example, assuming that detection algorithm generates a qualitative result for the excitement state expressed as a percentage, the conversion application may be configured to generate “excited!” as keyboard input when the excitement rises above 80% and generate “calm” as keyboard input when excitement drops below 20%.

The following table lists examples of states and associated input events that could be implemented in the look-up table:

| | |
|---|---|
| facial expression, smile | :-) |
| facial expression, frown | :-( |
| facial expression, wink | ;-) |
| facial expression, grin | :-D |
| emotion, happiness | :-) |
| emotion, sadness | :-( |
| emotion, surprise | :-O |
| emotion, embarrassment | :-*) |
| deliberative state, push | x |
| deliberative state, lift | c |
| deliberative state, rotate | z |

As an example of use, a user could wear the headset 12 while connected to a chat session. As a result, if the user smiles, a smiley face can appear in the chat session without any direct typing by the user.

If the application 32 supports graphic emoticons, then a code for the graphic emoticon could be used rather than the text.

In addition, it is possible to have input events that require a combination of multiple detections/triggers. For example, detection of both a smile and a wink simultaneously could generate the keyboard input “flirt!”. Even more complex combinations could be constructed with multiple Boolean logic operations.

Although the exemplary input events given above are fairly simple, the generated event can be configured to be more complex. For example, the events can include nearly any sequence of keyboard events, mouse events or joystick events. Keyboard events can include keystroke pressing, keystroke releasing, and a series of keystroke pressing and releasing on a standard PC keyboard. Mouse events can include mouse cursor movement, left or right clicking, wheel clicking, wheel rotation, and any other available buttons on the mouse.

In addition, in many of the examples given above, the input events remain representative of the state of the user (e.g., the input text “:-)” indicates that the user is smiling). However, it is possible for the converter application 40 to generate input events that do not directly represent a state of the user. For example, a detection of a facial expression of a wink could generate an input event of a mouse click.

If the system 10 includes a sensor 16 to detect the orientation of the subject's head, the conversion application 40 can also be configured to automatically convert data representing head orientation into conventional input events, e.g., mouse, keyboard or joystick events, as discussed above in the context of user states.

In some implementations, the conversion application 40 is configured to permit the end user to modify the mapping of state detections to input events. For example, the conversion application 40 can include a graphical user interface accessible to the end user for ease of editing the triggers and input events in the data structure. In particular, the conversion application 40 can be set with default mapping, e.g., smile triggers the keyboard input “:-)”, but the user is free to configure their own mapping, e.g., smile triggers “LOL”.

In addition, the possible state detections that the conversion application can receive and convert to input events need not be predefined by the manufacturer. In particular, detections for deliberative mental states need not be predefined. The system 10 can permit the user to perform a training step in which the system 10 records biosignals from the user while the user makes a willed effort for some result, and generates a signature for that deliberative mental state. Once the signature is generated, the detection can be linked to an input event by the converter application 40. The request for a training step can be called from the converter application 40. For example, the application 32 may expect a keyboard event, e.g., “x”, as a command to perform a particular action in a virtual environment, e.g., push an object. The user can create and label a new state, e.g., a state labeled “push”, in the converter application, associate the new state with an input event, e.g., “x”, initiate the training step for the new state, and enter a deliberative mental state associated with the command, e.g., the user can concentrate on pushing an object in the virtual environment. As a result, the system 10 will generate a signature for the deliberative mental state. Thereafter, the system 10 will signal the presence or absence of the deliberative mental state, e.g., the willed effort to push an object, to the converter application, and the converter application will automatically generate the input event, e.g., keyboard input “x” then the deliberative mental state is present.

In other implementations, the mapping of the detections to input events is provided by the manufacturer of the conversion application software, and the conversion application 40 is generally configured to prohibit the end user from configuring the mapping of detections to input events.

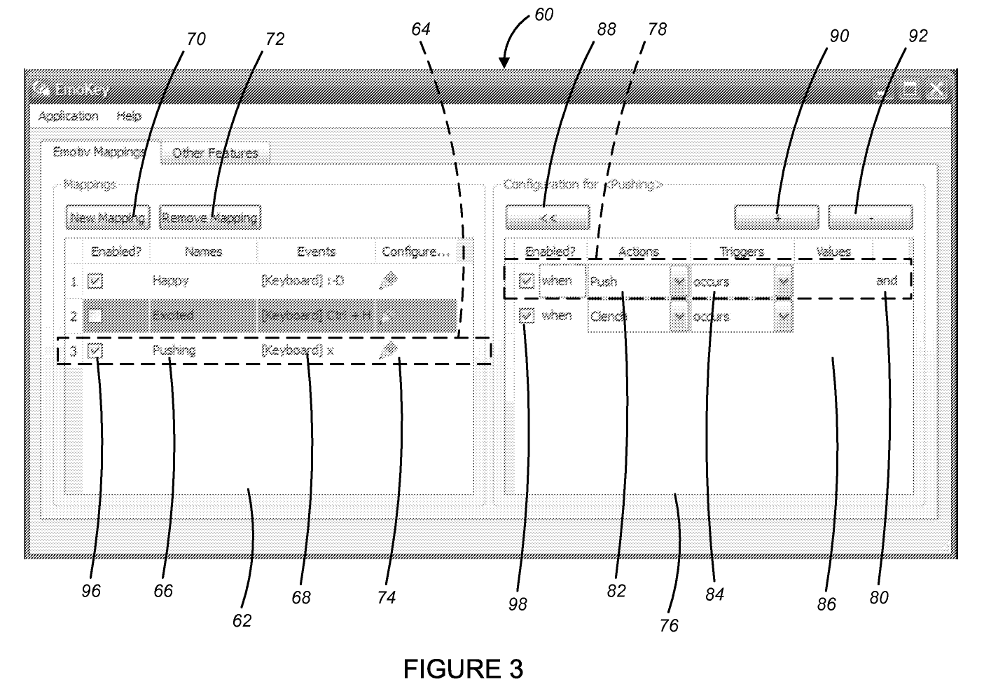

An exemplary graphical user interface (GUI) 60 for establishing mappings of detections to input events is shown in FIG. 3. The GUI 60 can include a mapping list region 62 with a separate row 64 for each mapping. Each mapping includes a user-editable name 66 for the mapping and the user-editable input event 68 to occur when the mapping is triggered. The GUI 60 can include buttons 70 and 72 which the user can click to add a new mapping or delete an existing mapping. By clicking a configure icon 74 in the row 64, the user can activate a trigger configuration region 76 to create or edit the triggering conditions for the input event. The triggering condition region 76 includes a separate row 78 for each trigger condition of the mapping and one or more Boolean logic operators 80 connecting the trigger conditions. Each row includes a user-selectable state 82 to be monitored and a user-selectable trigger condition 84 (in this interface, “occurs” is equivalent to the “Up” trigger type discussed above). The row 78 also includes a field 86 for editing threshold values for detection algorithm generates a qualitative result. The GUI 60 can include buttons 90 and 92 which the user can click to add a new trigger condition or delete an existing trigger condition. The user can click a close button 88 to close the triggering condition region 76.

The converter application 40 can also provide, e.g., by a graphical user interface, an end user with the ability to disable portions of the converter application so that the converter application 40 does not automatically generate input events. One option that can be presented by the graphical user interface is to disable the converter entirely, so that it does not generate input events at all. In addition, the graphical user interface could permit the user to enable or disable event generation for groups of states, e.g., all emotions, all facial expressions or all deliberative states. In addition, the graphical user interface could permit the user to enable or disable event generation independently on a state by state basis. The data structure could include field indicating whether event generation for that state is enabled or disabled. The exemplary GUI 60 in FIG. 3 includes a check-box 96 for each mapping in the mapping list region 62 to enable or disable that mapping. In addition, the GUI 60 includes a check box 98 for each trigger condition in the triggering condition region 76 to enable or disable that trigger condition. The graphical user interface can include pull-down menu, text-fields, or other appropriate fields.

In some implementations, some of the results of the state detection algorithms are input directly into application engine 32. This could be results for states for which the converter application 40 does not generate input events. In addition, there could be states which are input directly into application engine 32 and which generate input events into the application engine 32. Optionally, the application engine 32 can generate queries to the system 10 requesting data on the mental state of the subject 20.

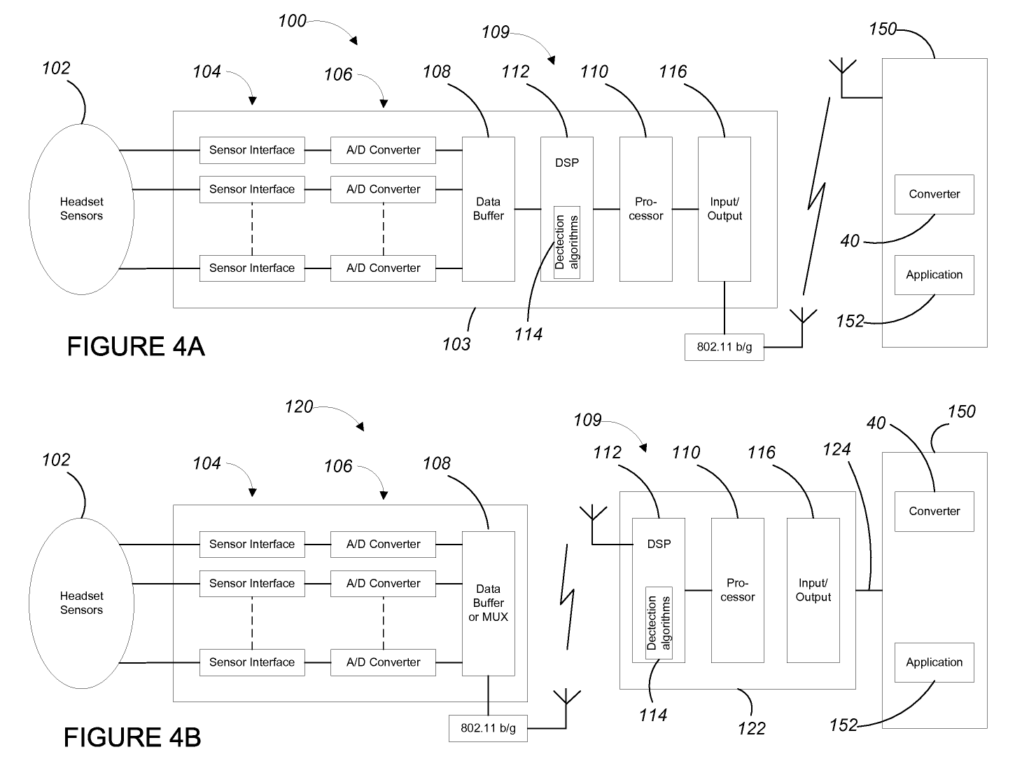

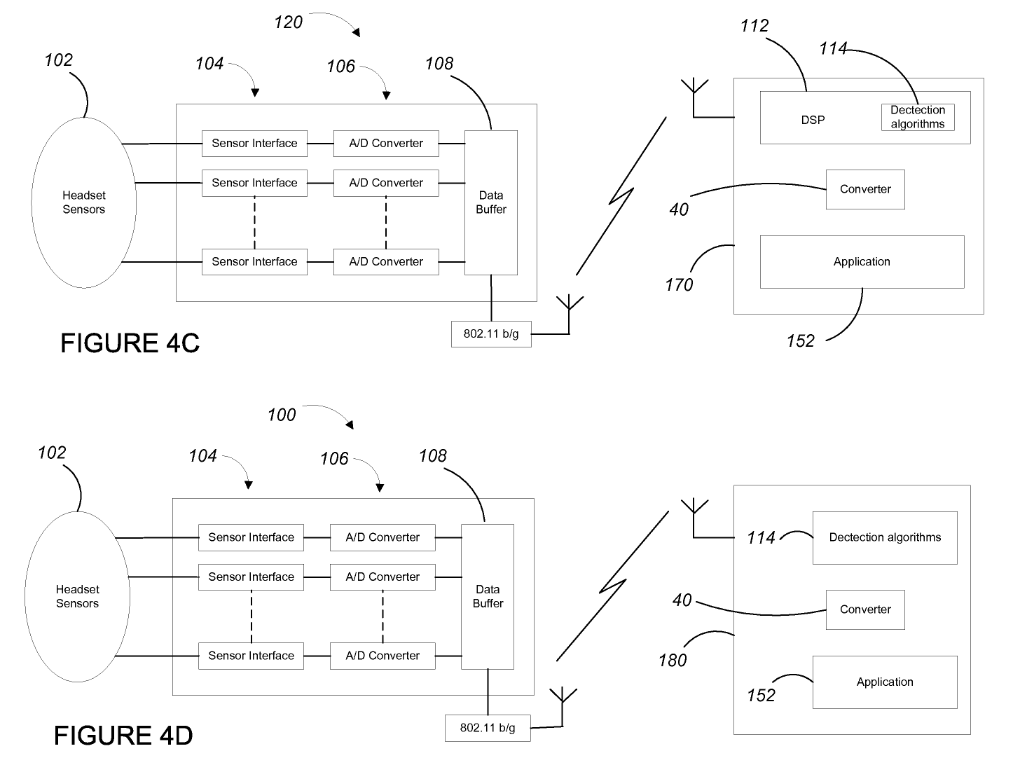

Turning to FIG. 4A, there is shown an apparatus 100 that includes the system for detecting and classifying mental states and facial expressions, and an external device 150 that includes the converter 40 and the system which uses the input events from the converter. The apparatus 100 includes a headset 102 as described above, along with processing electronics 103 to detect and classify states of the subject from the signals from the headset 102.

Each of the signals detected by the headset 102 is fed through a sensory interface 104, which can include an amplifier to boost signal strength and a filter to remove noise, and then digitized by an analog-to-digital converter 106. Digitized samples of the signal captured by each of the scalp sensors are stored during operation of the apparatus 103 in a data buffer 108 for subsequent processing. The apparatus 100 further includes a processing system 109 which includes a digital signal processor (DSP) 112, a co-processor 110, and associated memory for storing a series of instructions, otherwise known as a computer program or a computer control logic, to cause the processing system 109 to perform desired functional steps. The co-processor 110 is connected through an input/output interface 116 to a transmission device 118, such as a wireless 2.4 GHz device, a WiFi or Bluetooth device. The transmission device 118 connects the apparatus 100 to the external device 150.

Notably, the memory includes a series of instructions defining at least one algorithm 114 that will be performed by the digital signal processor 112 for detecting and classifying a predetermined state. In general, the DSP 112 performs preprocessing of the digital signals to reduce noise, transforms the signal to “unfold” it from the particular shape of the subject's cortex, and performs the emotion detection algorithm on the transformed signal. The detection algorithm can operate as a neural network that adapts to the particular subject for classification and calibration purposes. In addition to an emotion detection algorithms, the DSP can also store the detection algorithms for deliberative mental states and for facial expressions, such as eye blinks, winks, smiles, and the like. Detection of facial expression is described in U.S. patent application Ser. No. 11/225,598, filed Sep. 12, 2005, and in U.S. patent application Ser. No. 11/531,117, filed Sep. 12, 2006, each of which is incorporated by reference.

The co-processor 110 performs as the device side of the application programming interface (API), and runs, among other functions, a communication protocol stack, such as a wireless communication protocol, to operate the transmission device 118. In particular, the co-processor 110 processes and prioritizes queries received from the external device 150, such as a queries as to the presence or strength of particular non-deliberative mental states, such as emotions, in the subject. The co-processor 110 converts a particular query into an electronic command to the DSP 112, and converts data received from the DSP 112 into a response to the external device 150.

In this embodiment, the state detection engine is implemented in software and the series of instructions is stored in the memory of the processing system 109. The series of instructions causes the processing system 109 to perform functions of the invention as described herein. In other embodiments, the mental state detection engine can be implemented primarily in hardware using, for example, hardware components such as an Application Specific Integrated Circuit (ASIC), or using a combination of both software and hardware.

The external device 150 is a machine with a processor, such as a general purpose computer or a game console, that will use signals representing the presence or absence of a predetermined state, such as a non-deliberative mental state, such as a type of emotion. If the external device is a general purpose computer, then typically it will run the converter application 40 to generate queries to the apparatus 100 requesting data on the state of the subject, to receive input signals that represent the state of the subject and to generate input events based on the states, and one or more applications 152 that receive the input events. The application 152 can also respond to input events by modifying an environment, e.g., a real environment or a virtual environment. Thus, the mental state or facial expressions of a user can used as a control input for a gaming system, or another application (including a simulator or other interactive environment).

The system that receives and responds to the signals representing states can be implemented in software and the series of instructions can be stored in a memory of the device 150. In other embodiments, the system that receives and responds to the signals representing states can be implemented primarily in hardware using, for example, hardware components such as an Application Specific Integrated Circuit (ASIC), or using a combination of both software and hardware.

Other implementations of the apparatus 100 are possible. Instead of a digital signal processor, an FPGA (field programmable gate array) could be used. Rather than a separate digital signal processor and co-processor, the processing functions could be performed by a single processor. The buffer 108 could be eliminated or replaced by a multiplexer (MUX), and the data stored directly in the memory of the processing system. A MUX could be placed before the A/D converter stage so that only a single A/D converter is needed. The connection between the apparatus 100 and the platform 120 can be wired rather than wireless.

In addition, although the converter application 40 is shown as part of external device 150, it could be implemented in the processor 110 of the device 100.

Although the state detection engine is shown in FIG. 4A as a single device, other implementations are possible. For example, as shown in FIG. 4B, the apparatus includes a head set assembly 120 that includes the head set, a MUX, A/D converter(s) 106 before or after the MUX, a wireless transmission device, a battery for power supply, and a microcontroller to control battery use, send data from the MUX or A/D converter to the wireless chip, and the like. The A/D converters 106, etc., can be located physically on the headset 102. The apparatus can also have a separate processor unit 122 that includes a wireless receiver to receive data from the headset assembly, and the processing system, e.g., the DSP 112 and co-processor 110. The processor unit 122 can be connected to the external device 150 by a wired or wireless connection, such as a cable 124 that connects to a USB input of the external device 150. This implementation may be advantageous for providing a wireless headset while reducing the number of the parts attached to and the resulting weight of the headset. Although the converter application 40 is shown as part of external device 150, it could be implemented in the separate processor unit 122.

As another example, as shown in FIG. 4C, a dedicated digital signal processor 112 is integrated directly into a device 170. The device 170 also includes a general purpose digital processor to run an application 114 or application-specific processor that will use the information on the non-deliberative mental state of the subject. In this case, the functions of the mental state detection engine are spread between the headset assembly 120 and the device 170 which runs the application 152. As yet another example, as shown in FIG. 4D, there is no dedicated DSP, and instead the mental state detection algorithms 114 are performed in a device 180, such as a general purpose computer, by the same processor that executes the application 152. This last embodiment is particularly suited for both the mental state detection algorithms 114 and the application 152 to be implemented with software and the series of instructions is stored in the memory of the device 180.

Embodiments of the invention and all of the functional operations described in this specification can be implemented in digital electronic circuitry, or in computer software, firmware, or hardware, including the structural means disclosed in this specification and structural equivalents thereof, or in combinations of them. Embodiments of the invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple processors or computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

A number of embodiments of the invention have been described. Nevertheless, it will be understood that various modifications may be made without departing from the spirit and scope of the invention.

For example, the conversion application 40 has been described as implemented with a look up table, but the system can be implemented with a more complicated data structure, such as a relational database.

As another example, the system 10 can optionally include additional sensors capable of direct measurement of other physiological processes of the subject, such as heart rate, blood pressure, respiration and electrical resistance (galvanic skin response or GSR). Some such sensors, such sensors to measure galvanic skin response, could be incorporated into the headset 102 itself. Data from such additional sensors could be used to validate or calibrate the detection of non-deliberative states.

Accordingly, other embodiments are within the scope of the following claims.

What is claimed is:

1. A method of interacting with an application, comprising:
receiving, in a processor, data generated based on signals from one or more bio-signal detectors on a user, the data representing a mental state or facial expression of the user; and
generating an input event based on the data representing the mental state or facial expression of the user of the user; and
passing the input event to an application.

2. The method of claim 1, wherein the data represents a mental state of the user.

3. The method of claim 2, wherein the mental state comprises a non-deliberative mental state.

4. The method of claim 3, wherein the non-deliberative mental state comprises an emotion.

5. The method of claim 1, wherein the bio-signals comprise electroencephalograph (EEG) signals.

6. The method of claim 1, wherein the application is not configured to process the data.

7. The method of claim 1, wherein the input event comprises a keyboard event, a mouse event, or a joystick event.

8. The method of claim 1, wherein generating the input event includes determining whether the data matches a trigger condition.

9. The method of claim 8, wherein determining includes comparing the data to a threshold.

10. The method of claim 9, wherein determining includes determining whether the data has crossed the threshold.

11. The method of claim 9, wherein determining includes determining whether the data is above or below a threshold.

12. The method of claim 8, further comprising receiving user input selecting the input event.

13. The method of claim 8, further comprising receiving user input selecting the trigger condition.

14. A computer program product, tangibly stored on machine readable medium, the product comprising instructions operable to cause a processor to:
receive data representing a mental state or facial expression of a user;
generate an input event based on the data representing the mental state or facial expression of the user; and
pass the input event to an application.

15. A system, comprising:
a processor configured to receive data representing a mental state or facial expression of a user, generate an input event based on the datum representing of a state of the user, and pass the input event to an application.

16. The system of claim 15, further comprising another processor configured to receive bio-signal data, detect the mental state or facial expression from the bio-signal data, generate data representing the a mental state or facial expression, and direct the data to the processor.

17. The system of claim 16, further comprising a headset having electrodes to generate the bio-signal data.
